(19) United States
(12) Patent Application Publication
(10) Pub. No.: US 2010/0007500 A1
(43) Pub. Date: Jan. 14, 2010

(54) DETECTOR SYSTEM FOR DETECTING CARGO ITEMS FALLING DURING TRANSPORT AND METHOD FOR RETRIEVAL THEREOF

(75) Inventors: Jean-Christophe MESTRES, Vence (FR); Bernard PUCCI, Cagnes sur mer (FR); Jean-Louis VERAN, La Colle Sur Loup (FR)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 12/358,858

(22) Filed: Jan. 23, 2009

(30) Foreign Application Priority Data
Jul. 9, 2008 (FR) EPO 08305391.8

(51) Int. Cl. G08B 13/22

(52) U.S. Cl. 340/572.4

(57) ABSTRACT

A detector arrangement including an antenna for detecting an object or objects equipped with RFID tags and which has or have fallen from a transport arrangement during conveyance thereon from a first location to a second location. Also provided is a method of detecting and retrieving an object or objects that has or have fallen from a transport arrangement while in transit from a first location towards a second location. A Global Positioning System (GPS) may be provided to assist in retrieving the lost object or objects.

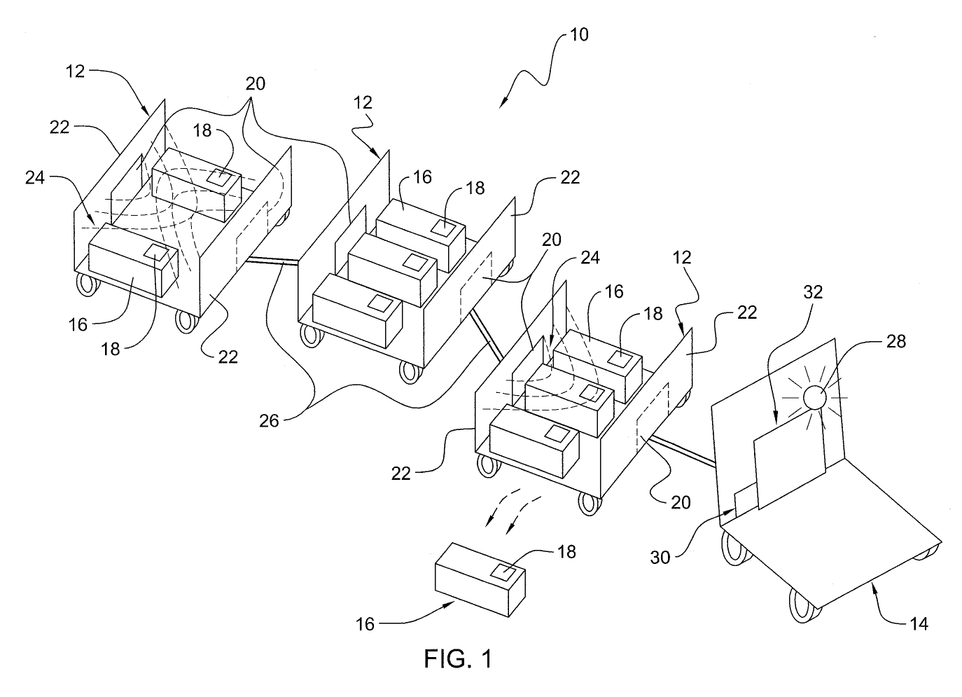

### BACKGROUND OF THE INVENTION

1. Field of the Invention

The present invention relates to a detector system for detecting one or more items of cargo or objects which has or have fallen from a transport arrangement during conveyance thereon from a first location to a second location, and particularly, although not limited thereto, while being conveyed between locations in an airport, terminal, railway or bus station towards an aircraft, train or vehicle, such as an intercity bus, and conversely, moreover, the present invention is also directed to a method of detecting one or more items of cargo that has fallen from a transport arrangement during transit from a first location, such as a terminal, towards a second location, an aircraft, train or intercity bus, and for the retrieval thereof.

Although at this time there are various technological solutions to solving encountered problems in recovering and tracking lost or fallen off luggage or items of cargo that are in a stage of being transported on carriers, the latter of which, for example, may be movable vehicles, which may, as required, be attached trolley-like to other carriers in the form of a train and driven by means of a tractor. The items of cargo initially loaded onto such carriers in airport terminals, train or bus stations, while being transported towards another location for loading on, respectively, an aircraft, railroad train or commercial bus are frequently carried in loose or unfettered conditions without any restraints against falling from the carrier. Consequently, upon occasion, while being transported along a curvilinear or zigzag path, or due to vibrations imparted to the carriers, items of cargo which may be supported on top of a luggage pile, or may not be well-positioned secured against shifting on the carrier, may drop off without being noticed by a driver of the tractor pulling the transport carrier or train of carriers. As a result, inasmuch as the driver may not readily or immediately notice the missing item or items of cargo, these may remain undiscovered on the roadway until found and picked up by someone, thereafter conveyed to the correct location based on identification or information provided on the particular item or items of cargo, such as an identification/destination tag, which has been previously attached thereto. Nevertheless, it is possible that the time interval which has elapsed between the cargo items falling off the moving carrier and having been located and conveyed to the appropriate destination, such as an aircraft, train or bus, may be too lengthy, with the latter having already departed, thereby requiring the retrieved item to remain behind and having to be shipped later on to its intended further destination.

2. Discussion of the Prior Art

Although various publications are currently known in the technology, in which an item of luggage or cargo is equipped with means, such as tags, for detecting the location thereof, normally there is not made any provision for the immediate or undelayed detection and recovery of the lost cargo or luggage item to enable prompt conveyance thereof to its intended destination.

Crider, et al, U.S. Patent Publication No. 2007/0222587 A1, discloses a method and apparatus for electronically tracking luggage, whereby the luggage is equipped with a tag having an implanted GPS chip, and where a separate receiving device is adapted to receive a transmitted signal from the luggage tag. This, in effect, enables luggage or items of cargo that have been lost or misplaced to be tracked in order to obtain real-time information regarding the status and location of the lost luggage. The GPS can also track luggage or cargo items while conveyed on a baggage truck, and enable the obtaining of information as to its continuously changing location and as to whether the luggage is being accessed by unauthorized persons. Although the foregoing apparatus is adapted to provide an electronic luggage tag utilizing GPS technology designed to prevent luggage thefts and to provide users with the ability to track the location of lost luggage, this is not applicable to instantaneously obtaining a signal during the transport thereof on a carrier so as to facilitate the immediate retrieval thereof by the driver of a tractor pulling the carrier without any significant delay.

Aupperle, et al., U.S. Pat. No. 7,088,242 B2, which is commonly assigned to the assignee of the present application, provides for an apparatus, method and system for tracking lost, misplaced or stolen personal articles by equipping the respective article with an RFID (Radio Frequency Identification) tag, wherein the article may have fallen out of the range of a tracking processor associated with a particular subscriber. Consequently, notification can be received that a vehicle containing the article is at a particular location so as to be able to retrieve the lost or stolen article. However, as in the previously cited publication to Crider, et al., there is no provision for the driver of a tractor pulling a carrier transporting items of luggage or cargo being able to instantaneously detect or sense the falling off of a particular item and to be able to alert the driver to retrieve the article without any undue delay, so as to be able to timely transport the retrieved item to its required destination at an aircraft, railway train or other vehicle, such as an intercity bus or the like.

PCT Application No. PCT/KR2005/003433 (Publication No. WO 2006-135134 A1) relates to electronic and telecommunications apparatus and method whereby baggage, such as an article of luggage equipped with an RFID tag, is adapted to prevent the luggage from being potentially, irretrievably lost in the event that the luggage is misplaced, in it can be tracked in due course by means of a suitable receiver obtaining tracking signals from the tag which consists of an RF, a memory and an antenna. However, as in the previously cited publications, there is no provision of a system or method for a practically instantaneous retrieval of the item of luggage or cargo which has fallen off the carrier, as it is received by so alert the driver of a tractor pulling a carrier transporting the item, enabling the driver to stop almost instantaneously and physically retrieve the article without any undue delay, thereby being able to timely convey or transport the item to its intended destination.

French Patent Publication No. FR8-2007-0130, similar to Aupperle, et al., discloses a method for tracking a lost or stolen article through the use of a Radio Frequency Identification (RFID) tag, which may have fallen out of the range of a tracking processor by forwarding an identifier for the RFID tags or the subscribers and receiving notification therefrom that the RFID has been sensed in proximity to a particular tracking processor coupled to at least one of the other subscribers.

Japanese Patent Publication Nos. JP 2004299878 A1 and JP 2005157507 A1 relate to aspects of determining the location of stolen or lost baggage by equipping the baggage with electronic tags to facilitate monitoring thereof. There is no disclosure of notifying a driver of a vehicle transporting the baggage, or raising an alarm analogous to the present invention to enable a rapid locating and retrieval of baggage that has fallen off a carrier transported by the vehicle.

### SUMMARY OF THE INVENTION

Accordingly, in order to obviate the disadvantages and drawbacks encountered in the prior art, the present invention is directed to a detector system, whereby the items of cargo are each equipped with an RFID tag, and a cargo transport arrangement is equipped with a therewith correlated RFID antenna which is operatively connected to a processor, including a display, such as a Personal Computer (PC), Laptop, Tablet PC or the like, which is mounted in the transport arrangement under the direction of an operator.

The items of cargo are detected upon their positioning in the transport arrangement through functioning of the processor, wherein the processor is in an acquisition mode, and if a particular item of cargo falls off the transport carrier, the processor or system will then fail to detect the presence thereof any longer, it being outside the detection range of the RFID antenna, and immediately raise an alarm alerting the personnel of the particular situation. Consequently, a switch from “acquisition” to “watch” can be automatically detected when the arrangement is “on” or under motion while, upon the arrangement stopping, the state thereof returns to the acquisition mode.

Upon making a stop, the operating personnel may implement a consistency check, i.e., on the display providing information as to the status of the cargo items, to ascertain if any particular item of cargo has either dropped off or been stolen. In the event the alarm is not detected by the personnel, but also for purposes of implemented a degree of traceability of the item of cargo, a GPS card may also be associated with the system in order to precisely locate the location of the fall of the item of cargo from the transport arrangement within the particular transportation or travel area, in effect, the traveling path taken by the arrangement between a point at which the items of cargo had been loaded on the transport arrangement which are to be conveyed towards the point within the transportation area, in essence, the destination for discharging the items of cargo at an aircraft, train or vehicle, such as an intercity bus, or the like.

Concerning the transport arrangement, although it is hereinbelow described as essentially a plurality of carriers attached to a drive vehicle, other suitable structures and arrangements of that type may readily ?run? themselves to the present invention. For example, the transport arrangement may consist of a single vehicle having a transport bay carrying one or more objects, which are equipped with the RFID tags and the bay incorporating one or more antenna, the vehicle may integrally contain a drive structure including a processor for receiving information from the antenna. Furthermore, numerous other types of transport arrangement may also be employed in conjunction with the present invention, and the embodiment detailed hereinbelow is primarily an exemplary structure, as will be appreciated by one skilled in this particular technology.

Accordingly, it is an object of the present invention o provide for a unique detector system for detecting cargo items or objects which are being conveyed by a transport arrangement and enabling the rapid locating and retrieval of any items or objects lost during transit.

Another object of the present invention resides in the provision of a method utilizing the detector system pursuant to the present invention.

### BRIEF DESCRIPTION OF THE DRAWINGS

Reference may now be made to the following detailed description of an embodiment of the invention, taken in conjunction with the accompanying single FIGURE of drawing, illustrating generally diagrammatically, by way of example only, a train of carriages transporting articles of luggage or cargo which are equipped with the RFID tags.

### DETAILED DESCRIPTION OF THE INVENTION

Referring now in specific detail to an embodiment of the present invention, as illustrated in the drawing, there is shown, by way of a non-limiting example, a luggage and cargo transport arrangement 10 comprising a plurality, in this instance three (3), luggage or cargo wheeled-carriers 12, which are coupled in a trolley-like train fashion and attached to a tractor 14, of which may be in the form of a cab-like vehicle. The tractor may include a support or seat for a driver for pulling the train of carriers 12 between various locations, such as from airport terminals, railway stations or bus terminals, along transportation paths within a specified transportation area, towards specified aircraft, railroad trains or land vehicles, for example, intercity busses, for receiving and loading the items of luggage or cargo, as designated, from the carriers 12.

Each of the items of luggage 16 or cargo is equipped with RFID (Radio Frequency Identification) tags 18, while each of the carriers 12 contains an antenna 20 built into the structures 22 thereof. The antennas 20 each have detection fields 24 extending between themselves, the RFID tags 18 located on the items of luggage 16 or cargo, when the latter are arranged on the respective carriers 12.

The couplings between the carriers 12 from trolley interconnections, which include wire connections 26 that also lead the tractor so as to form an antenna network. The tractor 14 is also equipped with an alarm device 28, serving a function as described hereinbelow.

The tractor 14 may also include an integrated Global Positioning System (GPS) 30 for locating any item of luggage 16 that has fallen off, in case of the carrier 12 not stopping during transit. The tractor 14 is equipped with a processor 32, which may be in the form of a display of either a PC, laptop, or the like, and the visual and/or audio alarm device which is observable by the driver of the tractor 14.

Accordingly, in the event that any item (or items) of luggage 16 or cargo falls off of the carriers 12, the luggage is no longer detected by the applicable antenna 20 associated with a particular RFID tag 18 on that item, since the item is outside the field of detection of that antenna. An alarm will be raised, in that the processor 32, which is in an acquisition mode during movement of the tractor 14, and which consolidates information received from all antennae 20, receives the information from that antenna detecting the missing item of luggage, activating the alarm device 28, enabling the falling off of the luggage 16 or cargo item to be detected in real-time, while the integrated GPS 30 arrangement in the tractor 14 locates the lost luggage 16 or cargo item in case the carrier does not stop.

The foregoing function will enable the driver to immediately stop the tractor 14 for retrieving the fallen off items, while the GPS 30 will determine the precise location where the luggage item has been lost or fallen off the respective carrier. Consequently, within a relatively short period of time, the driver is then able to retrieve the fallen off or lost item of luggage 16 or cargo and replace it on the applicable carrier 12 for continued conveyance to the final point of destination at the aircraft, train or bus.

While it is apparent that the invention herein disclosed is well calculated to fulfill the objects stated above, it will be appreciated that numerous modifications and embodiments may be devised by those skilled n the art, and it is intended that the appended claims cover all such modifications and embodiments as fall within the true spirit and scope of the present invention.

What is claimed is:

1. A detector system for detecting at least one object that is equipped with an RFID tag having been dropped off or removed from a transport arrangement, said detector system comprising:
at least one antenna on said transport arrangement having a transceiver attuned to said RFID tag and having a detection field for sensing said RFID tag within a predetermined range; and
a processor for receiving information from said at least one antenna regarding the presence of said at least one object on the transport arrangement during conveyance of said transport arrangement between first and second locations, whereby responsive to said at least one object having been removed from the range of the field of detection of said at least one antenna, said processor receives information from said at least one antenna alerting an operator of said transport arrangement to the loss of said at least one object.

2. A detector system as claimed in claim 1, wherein said processor comprises a display enabling an operator of said transport arrangement to readily ascertain the identity of at least one object.

3. A detector system as claimed in claim 2, wherein said processor comprises, selectively, a Personal Computer (PC), a laptop, or a Tablet PC.

4. A detector system as claimed in claim 1, wherein said transport arrangement includes an alarm device for triggering an alarm responsive to said object exiting from the detection field of said at least one antenna.

5. A detector system as claimed in claim 4, wherein said alarm device is triggered to raise an alarm responsive to said processor receiving information from said at least one antenna detecting the missing object.

6. A detector system as claimed in claim 4, wherein said alarm device raises an audio and/or visual alarm for alerting an operator of said transport arrangement.

7. A detector system as claimed in claim 1, wherein said transport arrangement includes a Global Positioning System (GPS) for precisely locating said at least one object in instances where said transport arrangement continues traveling so as to facilitate rapid retrieval thereof.

8. A detector system, as claimed in claim 1, wherein said transport arrangement comprises at least one carrier equipped with said at least one antenna for transporting said at least one object, and a drive vehicle equipped with said processor for towing said at least one carrier.

9. A detector system as claimed in claim 8, wherein a plurality of said carriers each equipped with an antenna are connected in a trolley sequence into a carrier train towed by said drive vehicle.

10. A detector system as claimed in claim 9, wherein said interconnected carriers include wire connections to form an antenna network consolidating information from all antennae for said processor so as to monitor the presence of objects being transported on said plurality of carriers, and to alert a driver of said drive vehicle of any missing object or objects.

11. A method of detecting at least one object that is equipped with an RFID tag and which has been dropped off or removed from a transport arrangement, said method comprising:
equipping said transport arrangement with at least one antenna having a transceiver attuned to said RFID tag and having a detection field for sensing said RFID tag within a predetermined range; and
providing said transport arrangement with a processor receiving information from said at least one antenna regarding the presence of said at least one object on the transport arrangement during conveyance of said transport arrangement between first and second locations, whereby responsive to said at least one object having been removed from the range of the field of detection of said at least one antenna, said processor receives information from said at least one antenna alerting an operator of said transport arrangement to the loss of said at least one object.

12. A method as claimed in claim 11, wherein said processor comprises a display enabling an operator of said transport arrangement to readily ascertain the identity of the at least one object.

13. A method as claimed in claim 12, wherein said processor is, selectively, a Personal Computer (PC), a laptop, or a Tablet PC.

14. A method as claimed in claim 11, wherein said transport arrangement is equipped with an alarm device triggering an alarm responsive to said at least one object exiting from the detection field of said at least one antenna.

15. A method as claimed in claim 14, wherein said alarm device is triggered to raise an alarm responsive to said processor receiving information from said at least one antenna detecting the missing object.

16. A method as claimed in claim 14, wherein said alarm device raises an audio and/or visual alarm for alerting an operator of said transport arrangement.

17. A method as claimed in claim 11, wherein said transport arrangement includes a Global Positioning System (GPS) for precisely locating said at least one object in instances where said transport arrangement continues traveling so as to facilitate rapid retrieval thereof.

18. A method as claimed in claim 11, wherein said transport arrangement comprises at least one carrier equipped with said at least one antenna for transporting said at least one object, and a drive vehicle equipped with said processor for towing said at least one carrier.

19. A method as claimed in claim 18, wherein a plurality of said carriers each equipped with an antenna are connected in a trolley sequence to form a carrier train towed by said drive vehicle.

20. A method as claimed in claim 18, wherein said interconnected carriers include wire connections forming an antenna network consolidating information from all antennae for said processor so as to monitor the presence of all objects transported on said plurality of carriers and alert an operator of said drive vehicle of any missing object or objects.

21. A program storage device readable by a machine tangibly embodying a program of instructions executable by the machine to perform method steps for controlling access to electronic information for detecting and retrieving lost objects, performing the steps of:
detecting at least one object that is equipped with an RFID tag and which has been dropped off or removed from a transport arrangement;
causing at least one antenna on said transport arrangement having a transceiver attuned to said RFID tag and having a detection field to sense said RFID tag within a predetermined range; and
having a processor receive information from said at least one antenna regarding the presence of said at least one object on the transport arrangement during conveyance of said transport arrangement between first and second locations, whereby responsive to said at least one object having been removed from the range of the field of detection of said at least one antenna, said processor receives information from said at least one antenna alerting an operator of said transport arrangement to the loss of said at least one object.

22. The program storage device as claimed in claim 21, further comprising the step of raising an alarm responsive to said at least one object exiting the range of the field of detection of said antenna alerting an operator of said transport arrangement.

23. The program storage device as claimed in claim 21, further comprising the step of having a Global Positioning System (GPS) precise locate said at least one lost object during continued travel of said transport arrangement.
